(19) United States
(12) Patent Application Publication
(10) Pub. No.: US 2012/0126969 A1
(43) Pub. Date: May 24, 2012

(54) AUTOMOTIVE VEHICLE WARNING SYSTEM

(75) Inventors: Paul Beringer Wilbur, West Bloomfield, MI (US); Paulus Thomas Geantil, San Diego, CA (US)

(73) Assignee: APTERA MOTORS, INC., Oceanside, CA (US)

(21) Appl. No.: 12/952,927

(22) Filed: Nov. 23, 2010

(51) Int. Cl. B60Q 1/26

(52) U.S. Cl. 340/466

(57) ABSTRACT

A visual and/or audio warning is provided during at least slow forward motion of an automobile vehicle. In another aspect, external music is emitted during only slow movement of an electric or hybrid vehicle. Other aspects of an electric or hybrid vehicle employ warning sounds (preferably music) directly from a vehicular outer body panel and/or the electric drive motor.

### BACKGROUND AND SUMMARY

The present invention generally pertains to automotive vehicles and more particularly to a warning system for an electric or hybrid vehicle.

Electric vehicles are extremely quiet during low-speed operation, especially as compared to vehicles having internal combustion engine. The conventional approach to resolve this concern is to add artificial engine noise or activate a monotone warning horn. Examples of such unpleasant warning noises are discussed in “Hybrid Cars Too Quiet for Pedestrian Safety? Add Engine Noise, Says Researchers,” Science Daily (2008). Further conventional disclosures of complicated, microphone-based and annoying noise warnings are disclosed in the following U.S. Patent Publication Nos.: 2010/0245069 entitled “Automobile Equipped With Speaker Unit” which published on Sep. 30, 2010; 2010/0208915 entitled “Vehicle Sound Simulation System” which published on Aug. 19, 2010; 2009/0066499 entitled “External Sound Generated System and Method” which published on Mar. 12, 2009; 2007/0257783 entitled “Vehicle Warning Device” which published on Nov. 8, 2007; and 2007/0229235 entitled “Vehicle-Mounted Sounding Device” which published on Oct. 4, 2007; all of which are incorporated by reference herein.

In accordance with the present invention, a visual and/or audio warning is provided during at least slow forward motion of an automotive vehicle. In another aspect, external music is emitted during only slow movement of an electric vehicle or hybrid vehicle. Other aspects of an electric or hybrid vehicle employ warning sounds directly emitted from a vehicular outer body panel and/or an electric drive motor in a multi-functional manner in order to reduce cost and weight of extraneous hardware components.

The present system is ideally suited for warning deaf and blind pedestrians of a quietly approaching vehicle. Furthermore, the present system allows for operator customization of the warning sounds, such as through operator selection of musical songs, as compared to conventional, standardized harsh warning noises. Additional advantages and features of the present invention will be found in the following description and accompanying claims, as well as in the appended drawings.

### BRIEF DESCRIPTION OF THE DRAWINGS

FIG. 1 is a perspective view of an automotive vehicle employing a warning system;

FIG. 2 is a fragmentary perspective view showing an interior of the automobile vehicle employing the warning system;

FIGS. 3-5 are electric schematics showing different embodiments of the automotive warning system; and

FIG. 6 is a logic flowchart for software employed in the automobile warning system.

### DETAILED DESCRIPTION

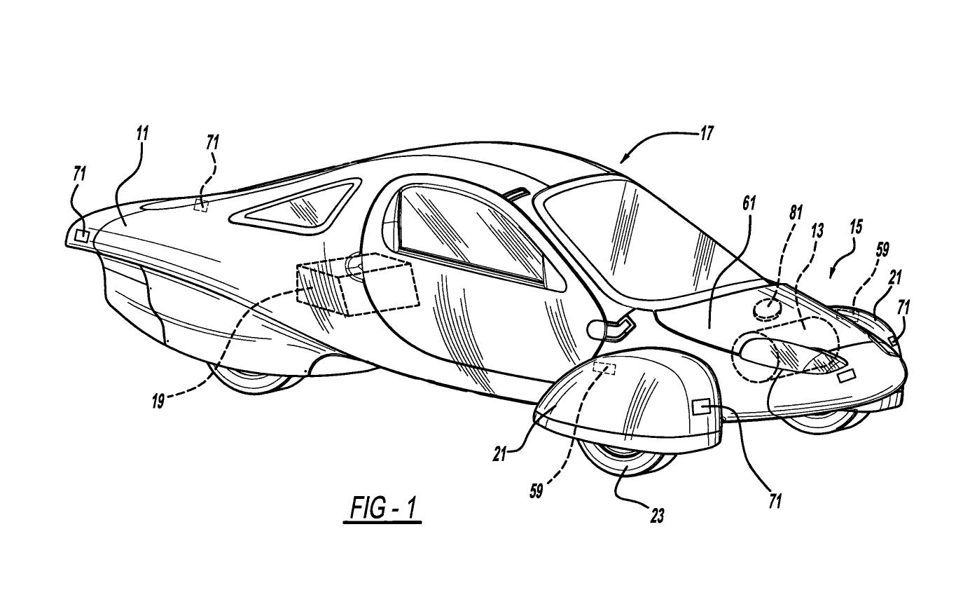

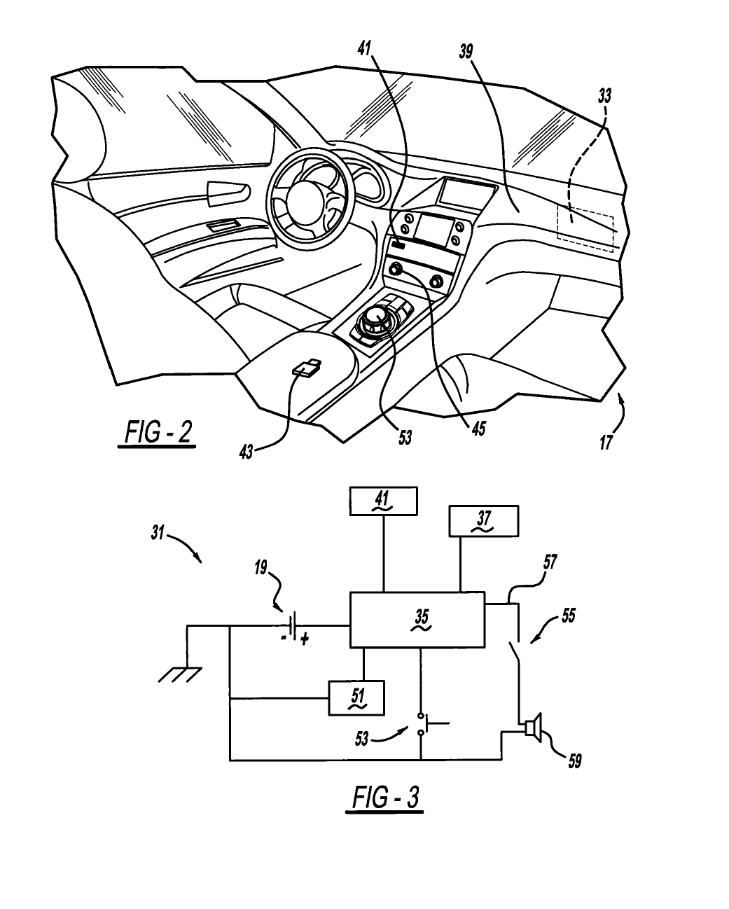

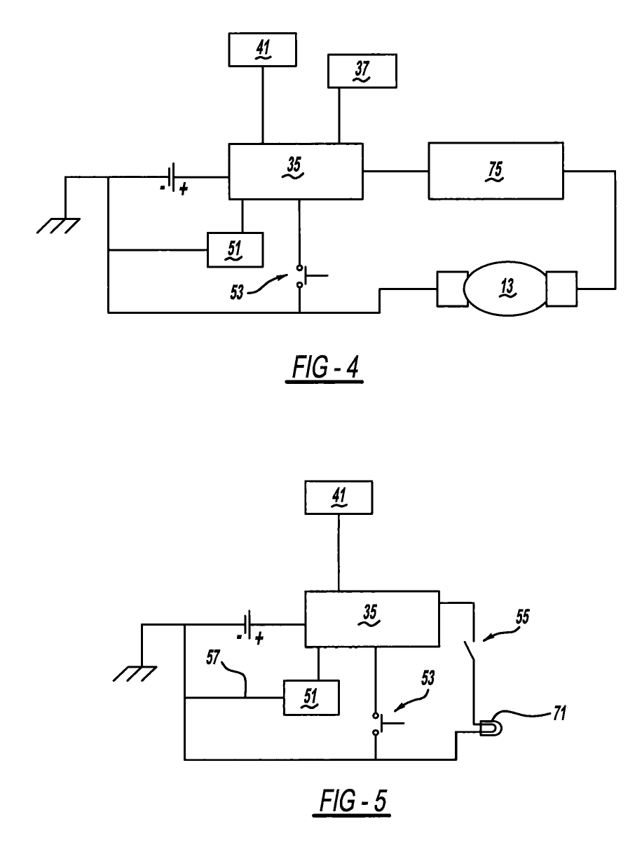

Referring to FIGS. 1, 2 and 3, a preferred embodiment of an automotive vehicle 11 has an electric drive traction motor 13 or, alternately a hybrid electric/internal combustion motor assembly, within a front engine compartment 15. A passenger compartment 17 is located rearward of engine compartment 15 and contains seats for the vehicle operator. A set of electric batteries 19 are contained within a battery compartment located behind the seats. Vehicle 11 further includes a pair of fenders 21 which are rotatable with front steering and drive wheels 23 powered by motor 13.

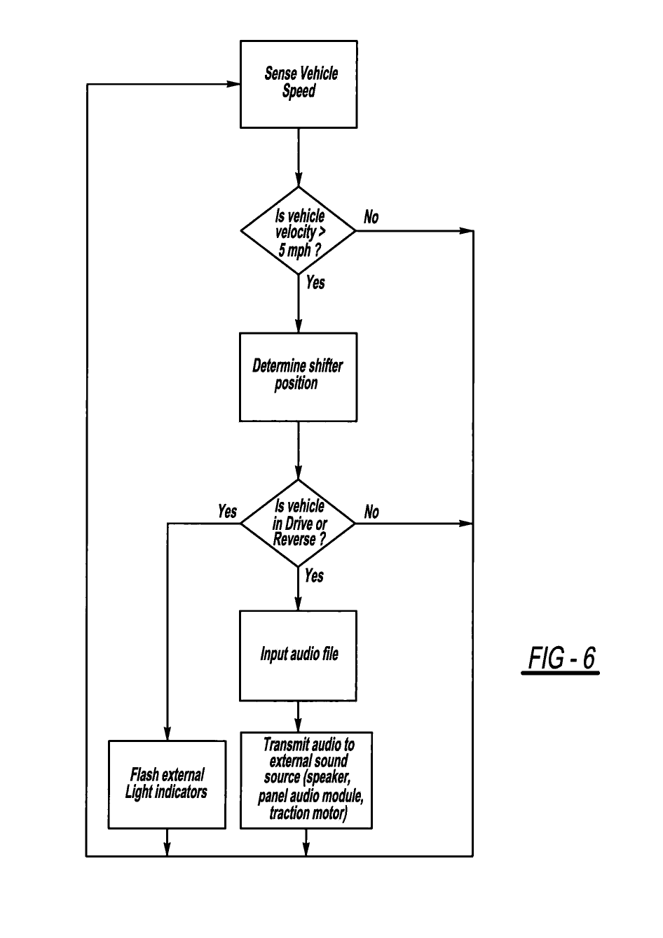

An automotive vehicle warning system 31 includes an electronic unit 33, including a microprocessor-based computer controller 35 and random access memory 37, which is located within an instrument panel 39 inside passenger compartment 17. Nontransient memory, such as RAM, ROM or a removeable storage device, connected to controller 35 includes programmed software (such as that illustrated in FIG. 6) instructions for operating the controller. A USB port 41 provides a communications interface with a removable and remote, hand-held music file storage device such as a memory stick 43. Alternately, port 41 can be replaced by a plug-in wire and pin connection, a Bluetooth® short wavelength radio transmission or frequency-hopping spread spectrum communication interface, or the like. Furthermore, memory stick 43 can alternately be replaced by a portable media player such as an iPOD® player, MP3 audioplayer, flash card, compact disc digital audio player, or the like.

A factory-installed music file is installed in memory 37 for automatic selection by controller 35 if an operator does not load and select a different music file. Nevertheless, the operator is encouraged to download music files from memory stick 43 to memory 37 via port 41, and to then use entertainment system controls 45 to select between desired music song signals to be sent from memory 37 to controller 35 with assistance from the software. For example, the operator may select three different music song files which are played sequentially or in a randomly shuffled manner, (with the operator sending a preference input signal to the software) and the operator may thereafter manually delete the previously selected music files and replace them with newer musical files by inputting associated signals to the software. It is also envisioned that the operator can select only a segment of a musical file for repeated use by controller via selection by the radio controls. For example, the operator can use the software and entertainment controls to mark start and end designations between which are only thirty seconds or less, or twenty bars or less of the musical song. It should be appreciated that the term “music” as used herein includes sound having a melody, harmony and/or rhymn, but does not include a mere repetition of monotone beeps, simulated engine noise or a continuous pitched siren. A musical song may include but is not limited to orchestral symphonies, cellular telephone simulating ring tones having more than two musical notes, percussion instrumentation having multiple notes or varying rhythms, and the like. As used herein, “music” is intended to be a pleasing sound to the vehicle operator.

A speed sensor 51, such as an optical encoder, hall effect sensor or the like senses RPM's from the transmission of the vehicle in order to detect and send a signal to controller 35 indicative of the speed of the vehicle. Controller 35 may actually consist of two or more spaced apart but interconnected microprocessor controllers, including but not limited to a body computer and an entertainment computer. Controller 35 also receives a signal from a shifter assembly 53 to determine if the shifter assembly is in a drive, reverse, park or neutral position, or has sent an associated signal. The controller then determines if the vehicle velocity is within the predetermined slow vehicle speed range, such as between 15-0 miles per hour, and more preferably less than or equal to 5 and greater than 0 miles per hour. If controller 35 determines that the vehicle shifter assembly is in either a drive or reverse mode and the sensed speed falls within the slow speed range, then the controller will access a selected or default music file from memory 37. Controller 35 will accordingly turn on an audio switch 55 within an electrical circuit 57 to send the music signals associated with the music file(s) to a sound emitter, preferably a loud speaker 59. Speaker 59 is water resistant and preferably includes a frusto-conical diaphragm, a voice coil and a magnet, which when energized vibrate the diaphragm to emit musical songs.

Speakers 59 are preferably hidden beneath a vehicular body panel, such as within fenders 21 or beneath a hood 61. Two or more speakers can be employed, one for each side of the vehicle, or alternately one for the front of the vehicle and one for the rear of the vehicle, or just one that is centrally located. The vehicular body panels are preferably made from epoxy resin encapsulated sheets of long-strand glass (or alternately polymeric) fibers, with a honeycomb core located between the sheets of fibers in a composite manner. Thus, speakers 59 emit desired musical songs external to the vehicle to warn pedestrians of the approaching electric or hybrid vehicle which would otherwise be almost silent.

As an additional option, a set of lights 71 is energized by microprocessor controller 35 dependent upon the sensed vehicle speed and transmission shifter mode. This is shown in FIGS. 1, 5 and 6. Lights 71 can either be hazard lamps externally mounted adjacent corners of the vehicle or dedicated visual indicator illumination devices mounted in another vehicle area. Controller 35 will activate switch 55 to vary a characteristic of each light 71. Such a characteristic includes but is not limited to sequential flashing or changing colors of one or more immediately adjacent light-emitting diodes, or alternately incandescent bulbs.

Reference should now be made to an alternate embodiment shown in FIGS. 1 and 4. When sensor 41 sends a signal to controller 35 that the slow speed range is present and when shifter assembly 51 sends a signal to controller 35 indicating that a drive or reverse transmission condition is present, the software within controller 35 will then send a set of instruction signals to a traction motor inverter/controller 75 located within engine compartment 15. Traction motor controller 75 will accordingly send audio modulation signals to cause harmonic vibrations within the mechanisms of traction motor 13. These harmonic vibrations will cause “motor singing” of traction motor 13 thereby directly causing traction motor to emit musical songs therefrom without the need for a separate speaker or the like. Such motor singing may require an ancillary solenoid or other electro-magnetic actuator to physically shift internal components within the traction motor in order to generate the different musical notes required to emit the desired musical song.

Another alternate embodiment is illustrated in FIG. 1 wherein a controller sends a music signal to a voice coil and magnet assembly 81 attached to an underside of the vehicular body panel, such as a hood 61. Voice coil and magnet assembly 81 serve to vibrate the body panel at different frequencies such that the body panel directly emits a musical song therefrom without requiring a separate speaker. It is also envisioned that the body panel may be a trunk lid, roof panel or other large outer panel of the vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The invention claimed is:

1. An automotive vehicle comprising:
a drive motor operable to move the vehicle in a forward direction, the drive motor being one of: (a) an electric motor, and (b) a hybrid electric/internal combustion motor assembly;
an electrical circuit including at least one sensor operably detecting if the vehicle is moving in the forward direction and at what speed;
at least one controller connected to the circuit and receiving a signal from the at least one sensor;
a sound emanator connected to the circuit; and
an external light connected to the circuit;
the at least one controller automatically causing the sound emanator to emit a musical song external to the vehicle if the sensor senses that the vehicle is moving in a forward direction at or less than a certain speed; and
the at least one controller automatically causing the light to change conditions external to the vehicle if the sensor senses that the vehicle is moving in a forward direction at or less than a certain speed.

2. The vehicle of claim 1, further comprising memory connected to the at least one controller, the musical song is stored in the memory as a default, the at least one controller causing the sound emanator to play the musical song to warn pedestrians of the moving vehicle.

3. The vehicle of claim 1, further comprising memory connected to the at least one controller, a driver-changeable music source interfacing with the memory so a driver can store at least one music file in the memory and change between the music files, the sound emanator emitting the musical song from the music file depending upon that selected by the driver.

4. The vehicle of claim 1, further comprising memory connected to the at least one controller, software operating the controller, and a remote music source using the software to download the musical song to the memory, the sound emanator emitting the musical song to warn pedestrians of the moving vehicle in response to instructions from the software.

5. The vehicle of claim 1, wherein the at least one controller causes the light to flash to warn pedestrians of the moving vehicle.

6. The vehicle of claim 1, wherein the at least one controller causes the light to change colors to warn pedestrians of the moving vehicle.

7. The vehicle of claim 1, wherein the light is located on a front half of the vehicle, further comprising a light located on a rear half of the vehicle which flashes if the vehicle is moving in reverse.

8. The vehicle of claim 1, wherein the at least one controller automatically causes the sound emanator to emit the musical song, and the light to repeatedly change conditions if the drive motor causes the vehicle to move in a rearward direction.

9. The vehicle of claim 1, wherein the sound emanator is an audio speaker, including a vibrating diaphragm, a voice coil and a magnet, the speaker being mounted beneath an outer vehicular body panel, and multiple different musical songs are automatically externally emitted from the speaker in an order selected by a vehicle operator.

10. The vehicle of claim 1, wherein the sound emanator is an outer vehicular body panel.

11. The vehicle of claim 1, wherein the sound emanator is the drive motor.

12. An automotive vehicle comprising:
a speed sensor;
at least one controller receiving a signal from the sensor and determining if the vehicle is moving and if so, if it is moving within a slow speed range;
memory connected to the at least one controller;
an external speaker receiving music signals from the memory if the at least one controller automatically determines that the vehicle is moving within the slow speed range; and
music files being loaded into the memory by vehicle operator, the music signals sent to the speaker being selectable from the music files by the operator, and a default music file being stored in the memory and emitted by the speaker if a music file is not loaded and by the operator.

13. The vehicle of claim 12, further comprising memory connected to the at least one controller, and a remote music source downloading at least one musical song to the memory, the speaker emitting the musical song to warn pedestrians of the moving vehicle.

14. The vehicle of claim 12, further comprising a light flashing to warn pedestrians of the vehicle only if the vehicle is moving in at least a forward direction within the slow speed range.

15. The vehicle of claim 12, further comprising a light changing colors to warn pedestrians of the vehicle moving in at least a forward direction within the slow speed range but not faster.

16. The vehicle of claim 12, wherein the vehicle is an electric vehicle and the speaker is hidden beneath a composite exterior body panel.

17. The vehicle of claim 12, further comprising a communications port connected to the memory and a hand-held remote audio source containing the music files being removeably connected to the port to allow for operator downloading of new music files for playing through the exterior speaker.

18. An automotive vehicle comprising:
a drive motor operable to move the vehicle in a forward direction, the drive motor being one of: (a) an electric motor, and (b) a hybrid electric/internal combustion motor assembly;
an exterior vehicular body panel;
a vibration source coupled to the body panel; and
a pedestrian warning sound transmitted to the vibration source and causing the body panel to act as an external speaker.

19. The vehicle of claim 18, wherein the sound is a musical song.

20. The vehicle of claim 18, further comprising:
a speed sensor;
at least one controller receiving a signal from the sensor and determining if the vehicle is moving and if so, if it is moving within a slow speed range;
memory connected to the controller;
the body panel receiving musical signals from the memory only if the controller automatically determines that the vehicle is moving within the slow speed range; and
music files being loaded into the memory by vehicle operator, the musical signals sent to the vibration source being selectable from the music files by the operator, and a default music file being stored in the memory.

21. The vehicle of claim 18, further comprising a light flashing to warn pedestrians only if the vehicle is moving in at least a forward direction within the slow speed range.

22. The vehicle of claim 18, wherein the body panel is a vehicular hood.

23. The vehicle of claim 18, wherein the body panel is a fiber-reinforced resin material.

24. An automotive vehicle comprising:
a drive motor operable to move the vehicle, the drive motor being one of: (a) an electric motor, and (b) a hybrid electric internal combustion motor assembly;
warning signals; and
a controller sending the warning signals to the drive motor which emits a warning sound directly therefrom.

25. The vehicle of claim 24, further comprising memory connected to the controller, the warning signals being driver-pleasing music stored in the memory as a default, and the controller causing the motor to externally emit the music from the drive motor to warn pedestrians of the moving vehicle.

26. The vehicle of claim 24, further comprising:
memory connected to the controller;
a driver-changeable music source interfacing with the memory so a driver can store the warning signals, which are at least one music file, in the memory and change between the music files; and
the motor directly emitting a musical song from the music file depending upon that selected by the driver.

27. A method of warning a pedestrian of otherwise quiet movement of an electric vehicle, the method comprising:
(a) sensing speed of the electric vehicle;
(b) determining if the electric vehicle is moving forward less than a predetermined speed;
(c) automatically transmitting a music file to a sound emitter affixed to the electric vehicle external to a passenger compartment if step (b) is positive;
(d) externally emitting a musical song from the emitter in response to step (c);
(e) repeatedly and automatically changing an external visual indicator if step (b) is positive; and
(f) manually changing music files to be externally emitted as desired by a vehicle operator.

28. The method of claim 27, further comprising only flashing the visual indicator which is a lamp if the vehicle is moving forward at a speed between about 0-15 mph, wherein the sound emitter is a speaker.

29. The method of claim 27, further comprising storing a default musical song for emission by the emitter if the operator does not select a music file.
